(19) United States
(12) Patent Application Publication
(10) Pub. No.: US 2025/0162294 A1
(43) Pub. Date: May 22, 2025

(54) FLEXIBLE LAMINATES WITH SUPERIOR SEALING PERFORMANCE

(71) Applicants: BOREALIS AG, Vienna (AT); ABU DHABI POLYMERS CO. LTD (BOROUGE) - SOLE PROPRIETORSHIP L.L.C., Abu Dhabi (AE)

(72) Inventors: Xinrong DUAN, Shanghai (CN); Antonios GITSAS, Linz (AT); Anthony BERTHELIER, Courbevoie (FR); Chantal SEMAAN, Barcelona (ES); Andrey BURYAK, Linz (AT); Subrata Kumar DAS, Abu Dhabi (AE); Raghvendra SINGH, Abu Dhabi (AE); Mohammad AL TALAFHA, Abu Dhabi (AE); Peter MALMROS, Singapore (SG)

(73) Assignees: BOREALIS AG, Vienna (AT); ABU DHABI POLYMERS CO. LTD (BOROUGE) - SOLE PROPRIETORSHIP L.L.C., Abu Dhabi (AE)

(21) Appl. No.: 18/839,301

(22) PCT Filed: Feb. 17, 2022
(86) PCT No.: PCT/CN2022/076552

§ 371 Date: Aug. 16, 2024

(51) Int. Cl. B32B 27/08; B32B 7/12; B32B 27/32; B32B 27/36; B65D 65/40

(52) U.S. Cl. CPC B32B 27/08; B32B 7/12; B32B 27/32; B32B 27/36; B65D 65/40; B32B 2307/72; B32B 2307/7376; B32B 2553/00

(57) ABSTRACT

The invention relates to a laminated film comprising a polyethylene sealant film comprising at least an outer layer O, an inner layer I and a core layer C, the core layer C being present between the outer layer O and the inner layer I, wherein the inner layer I is made of an inner layer composition comprising from 75 to 95 wt. % of a component AI that is a linear low density ethylene polymer having a density of from 915 to 925 kg/m³ and a melt flow rate (MFR₂) of from 0.5 to 3.0 g/10 min, determined according to ISO 1133, the wt. % being based on the total weight of the inner layer composition; and a substrate film laminated to the polyethylene sealant film, wherein the substrate film comprises a polyester polymer, selected from the group consisting of polyethylene terephthalate, polybutylene terephthalate and polytrimethylene terephthalate, and mixtures thereof; wherein the seal initiation temperature SIT (5 N) of the laminated film is less than 100° C., determined at the inner layer of the polyethylene sealant film according to ASTM F2029, ASTM F88.

The invention further relates to an article comprising the laminated film and to the use of laminated film for packaging of an article. Moreover, the invention relates to the use of the polyethylene sealant film for improving the sealing performance of a substrate film comprising a polyester polymer.

The present invention relates to a laminated film comprising a polyethylene sealant film and a substrate film comprising a polyester-based polymer. Further, the invention relates to an article comprising the laminated film, and to the use of the laminated film in packaging applications.

Laminated films in the packaging industry are often prepared from a flexible film structure comprising a polyethylene sealant film adhered to a substrate film commonly made of a polyester (e.g. PET), biaxially oriented polypropylene (BOPP) or biaxially oriented polyamide (BOPA). Laminated films are generally employed to match multi-functional requirements, i.e. the sealant film is employed for sufficient toughness-related properties and ensure package seal integrity and lower sealing temperature; whereas the substrate film is employed for stiffness and barrier-related properties to ensure improved shelf life of packed goods and its subsequent handling operations during packaging on Form, Fill & Seal (FFS) machines.

To achieve high speed in packaging processes, it is important that the sealing layer of the film has a low seal initiation temperature (SIT). The time to seal a package is reduced and the speed of the packaging line is increased with lower seal initiation temperature in the sealing layer.

Lower sealing temperature can, for example, be achieved by reducing the density of the polyethylene present in the sealing layer. However, polyethylene polymers with lower density suffer from several disadvantages. First, they are more expensive to produce as a higher comonomer content is required (which is usually more expensive than the ethylene monomer) in order to achieve density reduction of the polymer. Second, decrease in density of a polyethylene copolymer concurrently leads to a decrease in its melting point. This results in increased stickiness of the film and difficulties in handling while running on very high line speed machineries. Therefore, there is a need to develop film structures which contain moderately higher density polyethylene polymers in the sealing layer while having similar or even improved sealing performance reflected in the lower seal initiation temperature. Further, these film structures must meet all the requirements needed for their use in packaging applications, such as optical properties, aesthetics, stiffness, moisture and gas resistance etc.

Polyester-based film structures, such as PET films, have long been proven as suitable films in packaging applications. They are characterized by good stiffness and optical properties and, thus, are widely applied in this field.

For example, WO 2018/195269 describes a laminate structure for packaging application comprising a first film comprising biaxially-oriented polyethylene terephthalate (BOPET); and a second film laminated to the first film and comprising a co-extruded film, wherein the second film comprises a polyamide layer and a polyolefin layer, the polyolefin layer comprising a first composition, the first composition comprising at least one ethylene based polymer, wherein the first composition comprises a Molecular Weighted Comonomer Distribution Index (MWCDI) value greater than 0.9, and a melt index ratio (I₁₀/I₂) that meets the following equation: I₁₀/I₂≥7.0−1.2×log (I₂). No details on the sealing properties of the laminate structure are disclosed in this publication.

Many laminate structures on the market are prepared from several polymer classes. Separation and recycling of such laminates is difficult and expensive. However, there is a high demand on recyclability of today's packaging material.

In view of the above, it is a general object of the present invention to provide new laminate structures for packaging applications.

It is an object of the present invention to provide laminate structures based on the common and already established films, which have good heat resistance and mechanical properties and thus show excellent performance in high-speed VFFS operations, and at the same time show excellent sealing performance.

It is a further object of the present invention to provide laminate structures, which also suffice the aesthetic requirements addressed to films in packaging applications and have good optical properties (e.g. gloss and haze).

Finally, it is also an object of the present invention to provide laminate structures, which are relatively easy to recycle and on lower costs.

The combination of these objects is achieved by the present invention, which provides a laminated film comprising:
a) a polyethylene sealant film comprising at least an outer layer 0, an inner layer I and a core layer C, the core layer C being present between the outer layer 0 and the inner layer I, wherein the inner layer I is made of an inner layer composition comprising from 75 to 95 wt. % of a component AI that is a linear low density ethylene polymer (LLDPE) having a density of from 915 to 925 kg/m³ and a melt flow rate (MFR₂) of from 0.5 to 3.0 g/10 min, determined according to ISO 1133, the wt. % being based on the total weight of the inner layer composition; and
b) a substrate film laminated to the polyethylene sealant film, wherein the substrate film comprises a polyester polymer, selected from the group consisting of polyethylene terephthalate, polybutylene terephthalate and polytrimethylene terephthalate, and mixtures thereof;
   wherein the seal initiation temperature SIT (5 N) of the laminated film is less than 100° C., determined at the inner layer of the polyethylene sealant film according to ASTM F2029, ASTM F88.

The present invention is based on the finding that advantageous laminate structures can be provided as a laminated film by a combination of a polyester-based substrate film and a polyethylene sealant film, wherein the inner layer of the polyethylene sealant film comprises an LLDPE with specific properties and in a specific content, and wherein the seal initiation temperature SIT (5 N) of the laminated film at the inner layer of the polyethylene sealant film is as low as less than 100° C.

It was surprisingly found that the use of the LLDPE allows to achieve an improved sealing performance over other LLDPEs having the same density (e.g. of 918 kg/m³). The improvements are observed on the base sealant films before lamination as well as on the laminated films. Thus, reduction of density—which may be performed in order to decrease the sealing temperature—is not required, why the above-described drawbacks (e.g. stickiness, costs, etc.) do not occur.

Use of a polyethylene sealant film comprising the described composition together with a polyester-based substrate film provide laminated films, which benefit from the well-established properties of the substrate films in terms of their mechanical and optical properties, and additionally confer improved sealing performance to the laminated films. Further, the mechanical and optical properties of the substrate films are not significantly affected by the presence of the sealant film.

Thus, the polyethylene sealant film may be used to improve the sealing performance of polyester-based substrate films on the market.

Finally, the laminated films of the present invention have a relatively simple composition, based on a few polymer classes and, thus, are easier and less expensive to recycle than complex laminate structures.

In the present invention, the laminated film comprises, or consists of, a sealant film and a substrate film.

### Sealant Film

### Structure

The expression “sealant film” denotes a film that comprises a sealing layer, which is a layer that promotes bonding to another film, layer or article.

The sealant film according to the present invention comprises, or consists of, several layers, and at least an outer layer O, a core layer C and an inner layer I. The core layer C is located between the external layers, i.e. the outer layer O and the inner layer I. The inner layer I is the sealing layer of the sealant film.

In one embodiment, the sealant film consists of an outer layer O, a core layer C and an inner layer I. In another embodiment, the sealant film comprises one or more further intermediate (or sub-skin) layers X.

In a particular embodiment, the sealant film further comprises one or more intermediate layer(s) X between the core layer C and the inner layer I, and the core layer C and the outer layer O, for example in a five-layer film structure O/X1/C/X2/I or a seven-layer film structure O/X1/X1/C/X2/X2/I. Preferably, the sealant film comprises up to nine layers, more preferably up to seven layers.

If present, the intermediate layer(s) X preferably comprise(s), or consist(s) of, a composition similar to the composition of its neighboring layer, which may thus be a composition of the core layer C or either of a composition of the neighboring inner layer I or the neighboring outer layer O.

Preferably, the sealant film has a thickness of 35 to 120 μm, more preferably 40 to 110 μm and most preferably 40 to 100 μm.

In the sealant film, the core layer C preferably has a thickness of 30 to 80%, more preferably 35 to 75% and most preferably 40 to 70%, of the total sealant film thickness.

The outer layer O and/or the inner layer I preferably each has/have a thickness of 10 to 35%, preferably 15 to 30%, of the total sealant film thickness. In a five-layer film structure O/X1/C/X2/I, the inner layer I and/or the outer layer O preferably each has/have a thickness of 5 to 20% of, more preferably of 7.5 to 15%, of the total sealant film thickness.

The sealant film is a “polyethylene film”, i.e. a film that comprises, or consists of, at least one type of ethylene polymer, which may be a homopolymer or a copolymer of ethylene. Preferably, the polyethylene film comprises at least 90 wt. %, more preferably at least 95 wt. % and most preferably at least 98 wt. % of ethylene polymer, based on the total weight of the polyethylene film. Preferably, the polyethylene film comprises from 90 to 100 wt. %, more preferably from 95 to 100 wt. % and most preferably from 98 to 100 wt. % of ethylene polymer, based on the total weight of the polyethylene film. Most preferably, the polyethylene film consists of only ethylene polymer(s). Preferably, ethylene polymer comprises, or consists of, ethylene homopolymer and/or copolymer of ethylene with propylene and/or any of alpha-olefins having from 4 to 10 carbon atoms. Preferably, the polyethylene film does not contain non-polyolefin polymers, more preferably does not contain non-polyethylene polymers. Particularly preferred, the polyethylene film does not contain polyester or polyamide polymers.

Generally, sealant films may be provided as oriented or non-oriented films. An oriented film is a film that has been “stretched” after its production. Oriented films are typically stretched by more than 300%, in the machine direction (MD) and/or transverse direction (TD), preferably by 500% and more. Films stretched in machine direction are often referred to as “MDO” films. Films stretched in two directions are referred to as “bi-axially oriented polyethylene” (“BOPE”) films. A non-oriented film is a blown or cast film, which is not intentionally stretched after the film production (preferably, by more than 200%) by any suitable means i.e. subsequent heating and/or using the rollers during the film production.

Preferably, the sealant film is a non-oriented film. Preferably, the sealant film is produced on standard blown and/or cast film line through the standard film machine system (nip roller or take-off rollers and winders), without the use of any stretching units.

As is understood within the meaning of this disclosure, the sealant film and its respective layer compositions for layer preparation may also comprise additives such as stabilizers, processing aids and/or pigments. Examples of such additives are antioxidants, UV stabilizers, acid scavengers, nucleating agents, anti-block agents, slip agents etc. as well as polymer processing agents (PPA). The additives may be present in some or only in one layer of the film, in the same or in different contents. The additives may be added to the respective layer compositions during preparation of the compositions or may already be contained in any of the polymers used for the preparation of the respective layer compositions.

Generally, each of the additives may be present in an amount of 0 to 5000 ppm, based on the total weight of the respective layer composition used for the preparation of the layers of the film. The additives are generally available from several suppliers and are contained in compositions as single additive or as admixtures of two or more additives. Such compositions may generally be present in an amount of 0 to 5 wt. % in the layer composition(s), based on the weight of the respective layer composition used for the preparation of the layers of the film.

Generally, within the meaning of the present disclosure, the percentage (%) is to be understood as weight percentage (wt. %), unless otherwise indicated.

### Composition

Each of the sealant film layers is made of a composition comprising at least one polymeric (e.g. polyethylene) component. If the composition comprises more than one polymeric component, it is a blend of these components. Additional compounds (such as additives like polymer processing aids, anti-block or slip agents) may be present in the composition.

### Inner Layer I

The inner layer I is made of an inner layer composition comprising components, which particularly contribute to heat seal performance and optical properties of the film. The inner layer I of the sealant film is usually the sealing layer.

### Component AI

The inner layer I of the sealant film is made of an inner layer composition comprising a component AI, which is a linear low density ethylene polymer (LLDPE) having a density of from 915 to 925 kg/m³ and an MFR₂ of from 0.5 to 3.0 g/10 min, determined according to ISO 1133.

LLDPEs are well known in the art and are produced in polymerization processes using a catalyst.

Preferably, the component AI is a multimodal linear low density ethylene polymer, preferably a multimodal ethylene copolymer of ethylene with one or more comonomers selected from alpha-olefins having from 4 to 10 carbon atoms, more preferably a bimodal ethylene copolymer of ethylene with one or more comonomers selected from alpha-olefins having from 4 to 10 carbon atoms.

In a particular embodiment, the component AI is a multimodal, preferably a bimodal, copolymer of ethylene with two comonomers selected from alpha-olefins having from 4 to 10 carbon atoms, preferably 1-butene and 1-hexene, i.e. a multimodal terpolymer.

Preferably, the ethylene copolymer has a ratio MFR₂₁/MFR₂ of from 13 to 30 and/or an MWD of 6 or less.

Preferably, the ethylene copolymer comprises, or consists of, a multimodal polymer of ethylene with one or more comonomers selected from alpha-olefins having from 4 to 10 carbon atoms, which has a ratio MFR₂₁/MFR₂ of from 13 to 30 and an MWD of 6 or less.

Such multimodal ethylene copolymers are disclosed, for example, in WO2016/083208.

The multimodal ethylene copolymer preferably has an MFR₂ of from 1.0 to 2.0 g/10 min, and particularly preferred from 1.2 to 1.8 g/10 min.

Preferably, the multimodal ethylene copolymer has a density of from 915 to 925 kg/m³, more preferably of from 916 to 920 kg/m³.

The multimodal ethylene copolymer preferably has a ratio MFR₂₁/MFR₂ of from 13 to 30, more preferably from 15 to 25.

The multimodal ethylene copolymer preferably has an MWD of 6 or less and usually more than 1, more preferably of from 3 to 5.

The alpha-olefin comonomers having from 4 to 10 carbon atoms of the multimodal ethylene copolymer are preferably 1-butene and/or 1-hexene.

Preferably, the total amount of comonomers present in the multimodal ethylene copolymer is from 0.5 to 10 mol %, preferably from 1 to 8 mol %, more preferably from 1 to 5 mol %, still more preferably from 1.5 to 5 mol % and most preferably from 2.5 to 4 mol %.

In a preferred embodiment, the multimodal ethylene copolymer is a bimodal copolymer, i.e. it comprises a low molecular weight and a high molecular weight component, and has an MFR₂ of from 1.2 to 1.8 g/10 min, and/or an MFR₅ of from 3.0 to 5.0 g/10 min, and/or an MFR₂₁ of from 20 to 40 g/10 min, and/or a density of from 916 to 920 kg/m³, and/or a molecular weight distribution (MWD) of from 3 to 5, and/or an Mₙ of from 15 to 25 kg/mol, and/or an M_{w} of from 80 to 115 kg/mol, and/or an MFR₂₁/MFR₂ ratio (FRR_{21/2}) of from 15 to 25, and/or an MFR₂₁/MFR₅ ratio (FRR_{21/5}) of from 6 to 9.

In a further preferred embodiment, the component AI comprises, or consists of, a multimodal ethylene terpolymer.

Preferably, the multimodal ethylene terpolymer is an ethylene terpolymer having a density of from 915 kg/m³ to 925 kg/m³ and an MFR₂ of from 0.5 to 2.0 g/10 min.

The multimodal ethylene terpolymer preferably comprises, or consists of, a multimodal polymer of ethylene with at least two different comonomers selected from alpha-olefins having from 4 to 10 carbon atoms, which has a ratio MFR₂₁/MFR₂ of from 13 to 30 and an MWD of 5 or less.

Such multimodal ethylene terpolymers are disclosed, for example, in WO2016/083208. As far as definitions (such as for the “modality” of a polymer) and production methods for these ethylene terpolymers are concerned, it is referred to WO2016/083208. Furthermore, all embodiments and preferred embodiments of such ethylene terpolymers as described in WO2016/083208, which have a density in the range of from 915 to 925 kg/m³ are also preferred embodiments of the multimodal ethylene terpolymer in the present disclosure, whether or not explicitly described herein.

The multimodal ethylene terpolymer preferably has an MFR₂ of from 0.6 to 2.0 g/10 min, and particularly preferred from 1.2 to 1.8 g/10 min.

Preferably, the multimodal ethylene terpolymer has a density of from 915 to 925 kg/m³, more preferably from 916 to 920 kg/m³.

The multimodal ethylene terpolymer preferably has a ratio MFR₂₁/MFR₂ of from 13 to 30, more preferably from 15 to 25.

The at least two alpha-olefin comonomers having from 4 to 10 carbon atoms of the multimodal ethylene terpolymer are preferably 1-butene and 1-hexene.

Preferably, the total amount of comonomers present in the multimodal ethylene terpolymer is from 0.5 to 10 mol %, more preferably from 1 to 8 mol %, even more preferably from 1 to 5 mol %, still preferably from 1.5 to 5 mol % and most preferably from 2.5 to 4 mol %.

The multimodal ethylene terpolymer, which preferably is a bimodal terpolymer, preferably comprises, or consists of, an ethylene polymer component (A) and an ethylene polymer component (B), wherein the ethylene polymer component (A) has higher MFR₂ than the ethylene polymer component (B).

Preferably, the ethylene polymer component (A) has an MFR₂ of from 1 to 50 g/10 min, more preferably from 1 to 40 g/10 min, even more preferably from 1 to 30 g/10 min, still more preferably from 2 to 20 g/10 min, still more preferably from 2 to 15 g/10 min and most preferably from 2 to 10 g/10 min.

The ratio of the MFR₂ of ethylene polymer component (A) to the MFR₂ of the ethylene polymer component (B) is from 2 to 50, preferably from 5 to 40, more preferably from 10 to 30, even more preferably from 10 to 25 and most preferably from 11 to 25.

Preferably, the ethylene polymer component (A) comprises a different comonomer than the ethylene polymer component (B).

Preferably, the ethylene polymer component (A) has a lower amount (mol %) of comonomer than the ethylene polymer component (B), more preferably, the ratio of [the amount (mol %) of the alpha-olefin comonomer having from 4 to 10 carbon atoms comonomer present in ethylene polymer component (A)] to [the amount (mol %) of at least two alpha-olefin comonomers having from 4 to 10 carbon atoms of the final multimodal ethylene terpolymer] is of from 0.10 to 0.60, preferably from 0.15 to 0.50.

Preferably, the alpha-olefin comonomer having from 4 to 10 carbon atoms of the ethylene polymer component (A) is 1-butene and the alpha-olefin comonomer having from 4 to 10 carbon atoms of the ethylene polymer component (B) is 1-hexene.

Preferably, the ethylene polymer component (A) has different, preferably higher, density than the density of the ethylene polymer component (B).

The density of the ethylene polymer component (A) is preferably from 925 to 950 kg/m³, more preferably from 930 to 945 kg/m³.

Preferably, the multimodal ethylene terpolymer comprises the ethylene polymer component (A) in an amount of from 30 to 70 wt. %, more preferably from 40 to 60 wt. %, even more preferably from 35 to 50 wt. %, still more preferably from 40 to 50 wt. %; and the ethylene polymer component (B) in an amount of from 70 to 30 wt. %, more preferably from 60 to 40 wt. %, even more preferably from 50 to 65 wt. %, still more preferably from 50 to 60 wt. %, based on the total amount (100 wt. %) of the multimodal ethylene terpolymer.

Most preferably, the multimodal ethylene terpolymer consists of the ethylene polymer components (A) and (B) as the sole polymer components. Accordingly, the split between the ethylene polymer component (A1) to the ethylene polymer component (B1) is (30 to 70):(70 to 30) preferably (40 to 60):(60 to 40), more preferably (35 to 50):(65 to 50), still more preferably (40 to 50):(50 to 60).

In a preferred embodiment, the multimodal ethylene terpolymer has an MFR₂ of from 1.0 to 2.0 g/10 min, and/or has a molecular weight distribution (MWD) of from 3.0 to 5.0, and/or is a multimodal terpolymer of ethylene with two comonomers selected from alpha-olefins having from 4 to 10 carbon atoms, preferably 1-butene and 1-hexene.

In a further preferred embodiment, the multimodal ethylene terpolymer is a bimodal terpolymer comprising an ethylene polymer component (A) and an ethylene polymer component (B), wherein the ethylene polymer component (A) has a higher MFR₂ than the ethylene polymer component (B), and the ethylene polymer component (A) is a copolymer of ethylene and 1-butene and the ethylene polymer component (B) is a copolymer of ethylene and 1-hexene, preferably, wherein the total comonomer content in the multimodal ethylene terpolymer is from 1 to 5 mol %.

In a particularly preferred embodiment, the multimodal ethylene terpolymer is a bimodal terpolymer, i.e. comprises a low molecular weight and a high molecular weight component, and has an MFR₂ of from 1.2 to 1.8 g/10 min, and/or an MFR₅ of from 3.0 to 5.0 g/10 min, and/or an MFR₂₁ of from 20 to 40 g/10 min, and/or a density of from 916 to 920 kg/m³, and/or a molecular weight distribution (MWD) of from 3.0 to 5.0, and/or an Mₙ of from 15 to 25 kg/mol, and/or an M_{w} of from 80 to 115 kg/mol, and/or an MFR₂₁/MFR₂ ratio (FRR_{21/2}) of from 15 to 25, and/or an MFR₂₁/MFR₅ ratio (FRR_{21/5}) of from 6 to 9.

For all polymers described herein, all molecular weight parameters are measured by the GPC conventional method as further described in detail below, unless otherwise indicated. Comonomer content is measured by NMR spectroscopy as further described below.

Preferred multimodal ethylene terpolymers are also commercially available products such as Anteo™ from Borealis or Borouge having the properties as required herein, especially Anteo™ FK1828 or Anteo™ FK1820.

The component AI is present in an amount of from 75 to 95 wt. %, preferably from 75 to 85 wt. %, in the inner layer composition, based on the total weight of the inner layer composition.

The component AI is particularly suitable to impart low seal initiation temperature to the sealant film, while maintaining good optical properties.

### Component BI

The inner layer C composition may further comprise a component BI that is a low density ethylene polymer (LDPE), preferably having a density of more than 915 kg/m³.

LDPEs are well known in the art and are produced in high pressure processes usually performed in a tubular reactor or an autoclave.

LDPEs and their production are, for example, described in WO 2017/055174, page 9, line 29 to page 12, line 6, to which it is referred.

Preferably, the component BI has a density of from 918 to 928 kg/m³, more preferably from 919 to 927 kg/m³, and most preferably from 920 to 925 kg/m³.

Preferably, the component BI has an MFR₂ of from 1.5 to 2.5 g/10 min, more preferably from 1.6 to 2.4 g/10 min, determined according to ISO 1133.

In a preferred embodiment, has an MFR₂ of from 1.6 to 2.4 and a density of from 920 to 925 kg/m³.

In a particularly preferred embodiment, the component BI has an MFR₂ of from 1.6 to 2.4, and/or a density of from 920 to 925 kg/m³, and/or an MWD of from 5.5 to 9, and/or an Mₙ of from 12 to 18 kg/mol, and/or an M_{w} of from 80 to 130 kg/mol. All molecular weight parameters are determined by the GPC viscosity method in standard calibration as further described in detail below.

As the component BI, resin FT6230 or FT6236 as produced by Borealis or Borouge may be used.

The component BI is preferably present in an amount of from 5 to 25 wt. %, more preferably from 15 to 25 wt. %, in the inner layer composition, based on the total weight of the inner layer composition.

In one embodiment, the inner layer composition consists of the components AI and BI in any of the above-described embodiments.

### Additives

The inner layer composition may comprise additives, as described above.

In a particular embodiment, the inner layer composition comprises a slip agent, preferably in an amount of from 50 to 5000 ppm, and/or an anti-block agent, preferably in an amount of from 50 to 5000 ppm, each amount being based on the total weight of the inner layer composition.

Preferably, the slip agent comprises a compound selected from the group consisting of fatty acid amides, such as erucamide, oleamide or stearamide, and combinations thereof.

Preferably, the anti-block agent comprises a compound selected from the group consisting of inorganic compounds such as talc, kaolin, cristobalite, natural silica and synthetic silica, diatomaceous earth, mica, calcium carbonate, calcium sulfate, magnesium carbonate, magnesium sulfate, and feldspars, and combinations thereof.

The described additives may further improve the properties of the inner layer composition.

### Core Layer C

The core layer C of the sealant film is generally made of a core layer composition comprising components, which particularly contribute to stiffness and other mechanical properties like dart impact and tear resistance of the film. Although, due to the use of polyester-based substrates, the requirements on the sealant film in terms of mechanical properties such as stiffness are lower.

### Component AC

The core layer composition may comprise a component AC. Preferably, the component AC is linear low density ethylene polymer (LLDPE).

Preferably, the component AC is a multimodal linear low density ethylene polymer, more preferably a multimodal, such as a bimodal, linear low density ethylene copolymer of ethylene with a comonomer selected from alpha-olefins having from 4 to 10 carbon atoms. More preferably, the component AC is a copolymer of ethylene and 1-butene or 1-hexene, most preferred is 1-butene.

Preferably, the component AC has a density of from 915 to 925 kg/m³ and an MFR₂ of from 0.2 to 2.0 g/10 min, determined according to ISO 1133.

Such multimodal LLDPEs and their production are, for example, described in WO 2004/000933 A1, p. 9 to 12, to which it is referred, and WO 2021/013552.

In a first aspect, the component AC has a density of from 918 to 925 kg/m³, more preferably from 920 to 925 kg/m³, and an MFR₂ of from 0.2 to 0.5 g/10 min, more preferably, from 0.2 to 0.4 g/10 min.

Preferably, the total amount of comonomers present in the component AC of the first aspect is of from 2.0 to 6.0 mol %, more preferably from 2.5 to 5.5 mol %, and most preferably from 3.0 to 5.2 mol %.

In a particularly preferred embodiment of the first aspect, the component AC is a multimodal linear low density ethylene polymer, more preferably a bimodal linear low density ethylene copolymer of ethylene with a comonomer selected from alpha-olefins having from 4 to 10 carbon atoms, most preferred is 1-butene, and has an MFR₂ of from 0.2 to 0.4 g/10 min, and/or an MFR₅ of from 0.8 to 1.2 g/10 min and/or an MFR₂₁ of from 18 to 26 g/10 min, and/or a density of from 920 to 925 kg/m³, and/or a molecular weight distribution (MWD) of from 10 to 20, and/or an Mₙ of from 10 to 15 kg/mol, and/or an M_{w} of from 150 to 250 kg/mol, and/or an MFR₂₁/MFR₂ ratio (FRR_{21/2}) of from 80 to 110 and/or an MFR₂₁/MFR₅ ratio (FRR_{21/5}) of from 18 to 26.

In a second aspect, the component AC has a density of 915 to 920 kg/m³, more preferably of 916 to 920 kg/m³, and an MFR₂ of from 0.8 to 2.0 g/10 min, more preferably, from 0.8 to 1.5 g/10 min.

Preferably, the total amount of comonomers present in the component AC of the second aspect is of from 7.0 wt. % to 13.0 wt. %, preferably from 7.3 wt. % to 12.0 wt. %, still more preferably from 7.5 wt. % to 11.5 wt. % and most preferably from 7.7 wt. % to 11.0 wt. %, based on the total weight of monomer units in the AC component.

Preferably, the component AC of the second aspect comprises, or consists of, two ethylene-1-butene copolymer fractions (A1) and (B1), wherein the first ethylene-1-butene copolymer fraction (A1) has higher MFR₂ than the second ethylene-1-butene copolymer fraction (B1).

The first ethylene-1-butene copolymer fraction (A1) has a 1-butene content of from 0.5 wt. % to 7.5 wt. %, preferably from 0.6 wt. % to 5.0 wt. %, still more preferably from 0.7 wt. % to 3.5 wt. % and most preferably from 0.8 wt. % to 3.0 wt. %, based on the total weight of monomer units in the first ethylene-1-butene copolymer fraction (A1).

The first ethylene-1-butene copolymer fraction (A1) preferably has a density of from 915 kg/m³ to 955 kg/m, more preferably of from 925 kg/m³ to 950 kg/m³, and most preferably of from 935 kg/m³ to 945 kg/m³.

The first ethylene-1-butene copolymer fraction (A1) preferably consists of ethylene and 1-butene monomer units.

The first ethylene-1-butene copolymer fraction (A1) has a melt flow rate MFR₂ of from 1.0 g/10 min to less than 50.0 g/10 min, preferably of from 2.0 g/10 min to 45.0 g/10 min, still more preferably of from 3.0 g/10 min to 30.0 g/10 min, even more preferably of from 3.5 g/10 min to 20.0 g/10 min and most preferably of from 4.0 g/10 min to 10.0 g/10 min.

It is preferred that the first ethylene-1-butene copolymer fraction (A1) has a higher melt flow rate MFR₂ than the second ethylene-1-butene copolymer fraction (B1). It is further preferred that the first ethylene-1-butene copolymer fraction (A1) has a higher melt flow rate MFR₂ than the component AC.

The higher MFR₂ values of the first ethylene-1-butene copolymer fraction (A1) indicate a lower molecular weight, such as a lower weight average molecular weight M_{w} of the first ethylene-1-butene copolymer fraction (A1) compared to the second ethylene-1-butene copolymer fraction (B1) and/or the component AC.

The first ethylene-1-butene copolymer fraction (A1) is preferably present in the component AC in an amount of from 30 to 47 wt. %, more preferably of from 32 to 46 wt. % and most preferably from 35 to 45 wt. %, based on the total weight of the component AC.

The first ethylene-1-butene copolymer fraction (A1) is usually polymerized as the first polymer fraction in a multistage polymerization process with two or more polymerization stages in sequence. Consequently, the properties of the first ethylene-1-butene copolymer fraction (A1) can be measured directly.

The second ethylene-1-butene copolymer fraction (B1) has a 1-butene content of from 10.0 wt. % to 25.0 wt. %, preferably from 12.5 wt. % to 22.0 wt. %, still more preferably from 15.0 wt. % to 21.0 wt. % and most preferably from 16.0 wt. % to 20.0 wt. %, based on the total weight of monomer units in the second ethylene-1-butene copolymer fraction (B1).

The second ethylene-1-butene copolymer fraction (61) preferably has a density of from 870 kg/m³ to 912 kg/m, more preferably of from 880 kg/m³ to 910 kg/m, and most preferably of from 890 kg/m³ to 905 kg/m³.

The second ethylene-1-butene copolymer fraction (B1) preferably consists of ethylene and 1-butene monomer units.

The second ethylene-1-butene copolymer fraction (B1) has a melt flow rate MFR₂ of from 0.05 g/10 min to less than 1.0 g/10 min, preferably of from 0.1 g/10 min to 0.8 g/10 min, still more preferably of from 0.2 g/10 min to 0.7 g/10 min, and most preferably of from 0.3 g/10 min to 0.6 g/10 min.

It is further preferred that the second ethylene-1-butene copolymer fraction (61) has a lower melt flow rate MFR₂ as the component AC.

The lower MFR₂ values of the second ethylene-1-butene copolymer fraction (61) indicate a higher molecular weight, such as a higher weight average molecular weight M_{w} of the second ethylene-1-butene copolymer fraction (61) compared to the first ethylene-1-butene copolymer fraction (A1) and/or the component AC.

The second ethylene-1-butene copolymer fraction (61) is usually polymerized as the second polymer fraction in the presence of the first ethylene-1-butene copolymer fraction (A1) in a multistage polymerization process with two or more polymerization stages in sequence. Consequently, the properties of the second ethylene-1-butene copolymer fraction (B1) are not accessible to direct measurement but have to be calculated. Suitable methods for calculating the comonomer content, density and MFR₂ of the second ethylene-1-butene copolymer fraction (B1) are described in WO 2021/013552.

The second ethylene-1-butene copolymer fraction (B1) is preferably present in the component AC in an amount of from 43 to 65 wt. %, more preferably of from 44 to 62 wt. % and most preferably from 45 to 60 wt. %, based on the total weight of the component AC.

The weight ratio of the first ethylene-1-butene copolymer fraction (A1) to the second ethylene-1-butene copolymer fraction (B1) in the component AC is preferably from 35:65 to 47:53, more preferably from 37:63 to 46:54 and most preferably from 40:60 to 45:55.

In one preferred embodiment of the present invention the component AC consists of the first ethylene-1-butene copolymer fraction (A1) and the second ethylene-1-butene copolymer fraction (B1).

In a particularly preferred embodiment of the second aspect, the component AC is a multimodal linear low density ethylene polymer, more preferably a bimodal linear low density ethylene copolymer of ethylene with a comonomer selected from alpha-olefins having from 4 to 10 carbon atoms, most preferred is 1-butene, comprising two ethylene-1-butene copolymer fractions (A1) and (B1), and has an MFR₂ of from 0.8 to 1.5 g/10 min, and/or an MFR₂₁ of from 15 to 35 g/10 min, and/or a density of from 915 to 920 kg/m³, and/or an MFR₂₁/MFR₂ ratio (FRR_{21/5}) of from 15 to 25.

As the component AC, resin Borstar FB2230 as produced by Borealis or Borouge or resin Anbiq™ FM1810 or FM1818 as produced by Borouge may be used.

Preferably, the component AC is present in an amount of from 50 to 90 wt. %, more preferably from 60 to 85 wt. %, in the core layer composition, based on the total weight of the core layer composition.

### Component BC

The core layer composition may comprise a component BC that is a low density ethylene polymer (LDPE). Preferably, the component BC is an LDPE as described for the component BI of the inner layer composition, preferably having a density of 918 to 928 kg/m³ and/or an MFR₂ of 1.5 to 2.5 g/10 min, determined according to ISO 1133.

All embodiments described for the component BI are embodiments of the component BC. The component BC may be selected from any one of these embodiments independently, and the selected embodiment may be the same or different for BC and BI.

Preferably, the component BC is present in an amount of from 10 to 40 wt. %, more preferably from 15 to 25 wt. %, in the core layer composition, based on the total weight of the core layer composition.

In one embodiment, the core layer composition comprises, or consists of, the components AC and BC in any of the above-described embodiments.

In a preferred embodiment, the core layer composition comprises, or consists of, the component AC in an amount of from 50 to 90 wt. %, and the component BC in an amount of 10 to 40 wt. % a, based on the total weight of the core layer composition.

Further ethylene polymer components may be comprised in the core layer composition, such as other LLDPE or LDPE.

### Outer Layer O

The outer layer O of the sealant film is made of an outer layer composition comprising one or more components. In the laminated film, the outer layer O may be disposed between the core layer C and the substrate film, and it contributes to the mechanical and optical properties of the film.

### Component AO

The outer layer composition may comprise a component AO. Preferably, the component AO is linear low density ethylene polymer (LLDPE), as described for the component AC of the core layer composition.

All embodiments described for the component AC are embodiments of the component AO. The component AO may be selected from any one of these embodiments independently, and the selected embodiment may be the same or different for AO and AC.

Preferably, the component AO is present in an amount of from 50 to 90 wt. %, more preferably from 60 to 85 wt. %, in the outer layer composition, based on the total weight of the outer layer composition.

### Component BO

The outer layer composition may comprise a component BO that is a low density ethylene polymer (LDPE). Preferably, the component BO is an LDPE as described for the component BI of the inner layer composition, preferably having a density of 918 to 928 kg/m³ and/or an MFR₂ of 1.5 to 2.5 g/10 min, determined according to ISO 1133.

All embodiments described for the component BI are embodiments of the component BO. The component BO may be selected from any one of these embodiments independently, and the selected embodiment may be the same or different for BO and BI.

Preferably, the component BO is present in an amount of from 10 to 40 wt. %, more preferably from 15 to 25 wt. %, in the outer layer composition, based on the total weight of the outer layer composition.

In one embodiment, the outer layer composition comprises, or consists of, the components AO and BO in any of the above-described embodiments.

In a preferred embodiment, the outer layer composition comprises, or consists of, the component AO in an amount of from 50 to 90 wt. %, and the component BO in an amount of 10 to 40 wt. % a, based on the total weight of the outer layer composition.

Further ethylene polymer components may be comprised in the outer layer composition, such as other LLDPE or LDPE.

In a particular embodiment, the core layer composition and the outer layer composition comprise the same components, optionally in the same amounts.

In a preferred embodiment, the polyethylene sealant film comprises from 70 to 95 wt. % of an ethylene polymer having a density of from 915 to 925 kg/m³ and from 5 to 30 wt. % of a low density ethylene polymer (LDPE), both wt. % being based on the total weight of the polyethylene sealant film. These properties can be reached by the use of the above-specified ethylene polymers in the respective layers, and optionally the presence of additional ethylene polymers having the required properties.

### Properties

The sealant film shows excellent sealing behavior through lower seal initiation and hot tack temperatures (e.g. SIT below 95° C. in the single sealant film, i.e. before lamination). These properties may be achieved by the use of the component AI in the inner layer of the sealant film, and may be additionally improved by the presence of the component BI.

The mechanical and optical properties of the sealant film are in a range well suitable as sealant films for laminated structures for packaging applications.

Preferably, the sealant film (before lamination) has a seal initiation temperature at 5 N (SIT) of less than 100° C., preferably less than 95° C., such as less than 92° C., when measured at the inner layer C of the sealant film. Preferably, the sealant film (before lamination) has a seal initiation temperature at 5 N (SIT) of from 80 to 100° C., preferably from 85 to 95° C., when measured at the inner layer C of the sealant film. The seal initiation temperature at 5 N (SIT) is determined according to ASTM F 2029 and ASTM F 88.

Preferably, the sealant film (before lamination) has a hot tack temperature at 1 N of less than 95° C., preferably less than 90° C., when measured at the inner layer C of the sealant film. Preferably, the sealant film (before lamination) has a hot tack temperature at 1 N of from 80 to 95° C., preferably from 82 to 90° C., when measured at the inner layer C of the sealant film. The hot tack temperature at 1 N is determined according to ASTM F1921.

Preferably, the sealant film (before lamination) has a haze value of less than 14%, more preferably of less than 12%. Preferably, the sealant film (before lamination) has a haze value of from 3 to 14%, most preferably of from 5 to 12%. The haze value is determined according to ASTM D1003 as a measure for the transparency of the film and the value indicates good transparency.

Preferably, the sealant film (before lamination) has a dart drop impact (DDI) of at least 200 g, more preferably at least 250 g. Preferably, the sealant film (before lamination) has a dart drop impact (DDI) of from 200 to 600 g, more preferably of from 250 to 500 g. The dart drop impact (DDI) is determined according to ASTM D1709 “method A”, preferably on sealant films of a thickness of from 35 to 120 μm, more preferably 40 to 110 μm and most preferably 40 to 100 μm.

Preferably, the sealant film (before lamination) has a coefficient of friction of less than 0.50, more preferably of less than 0.40. Preferably, the sealant film (before lamination) has a coefficient of friction of from 0.05 to 0.50, more preferably from 0.10 to 0.40. The coefficient of friction is determined according to ISO 8295 at dynamic condition (in/in or out/out).

### Preparation

The sealant films are generally prepared by a conventional process for the preparation of multilayered films, wherein the layers of the films are co-extruded.

The different polymer components in any of the layers of the film are typically intimately mixed prior to layer formation, for example using a twin screw extruder, preferably a counter-rotating extruder or a co-rotating extruder. Then, the blends are converted into a coextruded film.

The films can be produced by blown film or cast film process. In order to manufacture such multilayered films, for example generally at least two polymer melt streams are simultaneously extruded (i.e. coextruded) through a multi-channel tubular, annular or circular die to form a tube which is blown-up, inflated and/or cooled with air (or a combination of gases) to form a film. Manufacture of blown films is well-known.

The blown (co-)extrusion can be performed at a temperature in the range 150° C. to 230° C., more preferably 160° C. to 225° C. and cooled by blowing gas (generally air) at a temperature of 10 to 40° C., more preferably 12 to 16° C. to provide a frost line height of 0.5 to 4 times, more preferably 1 to 2 times the diameter of the die. The blow up ratio (BUR) should generally be in the range of 1.5 to 3.5, preferably 2.0 to 3.0, more preferably 2.1 to 2.8.

As the sealant film is preferably a non-oriented film, it is preferably not subjected to a stretching step for possible orientation.

### Substrate Film

The expression “substrate film” denotes a film that contributes to mechanical, heat resistance and/or optical properties of the laminated film.

The substrate film comprises, or consists of, a polyester polymer, selected from the group consisting of polyethylene terephthalate (PET), polybutylene terephthalate (PBT) and polytrimethylene terephthalate (PTT), and mixtures thereof; preferably the polyester polymer comprises, or consists of, polyethylene terephthalate (PET).

Any PET, PBT and PTT film known in the art may be used as a substrate film for the laminated film of the present invention.

Such polyester-based films generally contribute to film stiffness, heat resistance, puncture resistance and/or barrier properties of the laminated film.

In a preferred embodiment, the substrate film is a polyethylene terephthalate (PET) film, i.e. it essentially (i.e. to at least 95 wt. %, more probably 97 wt. %) consists of polyethylene terephthalate and optional additives used for PET polymers.

Generally, polyester-based polymers contain, if desired, the additives customary for improving the slip or antifriction properties. Such additives are, for example, inorganic pigments, such as CaCO₃, SiO₂, kaolin, BaSO₄ and TiO₂, or crosslinked organic polymer particles. Additional customary additives, such as nucleation agents, antioxidants, antistatics, thermostabilizers, UV-blocking or UV-absorbing additives, flame retardant additives, waxes and dyes, may also be added as is conventionally known.

Polyester-based films are generally produced by extrusion. The molten polyester material is extruded through a flat-film die and chilled as an amorphous prefilm on a chill roll. This film is subsequently reheated and stretched in the longitudinal and transverse directions, or in the transverse and longitudinal directions, or in the longitudinal, transverse and again in the longitudinal direction. The stretching temperatures are generally between 100 to 130° C. The draw ratio for longitudinal stretching is from about 2 to 6, and preferably 3 to 4.5. The draw ratio for transverse stretching is from about 2 to 5, particular from 3 to 4. Where appropriate, the draw ratio of the second longitudinal stretching may be from about 1.1 to 3. The first longitudinal stretching may, if desired, be carried out at the same time as the transverse stretching (simultaneous stretching). Drawing is followed by thermosetting of the film at 150 to 240° C., in particular 180 to 220° C., thus greatly reducing the tendency of the film to shrink.

The substrate film may be a non-oriented or an oriented film. Particularly preferred is an oriented substrate film, such as an oriented PET film, e.g. biaxially oriented PET film (“BOPET”).

The substrate film may be built up in one or more layers, the individual layers comprising the polyester polymer and essentially differing only in the additives. Multilayer films are generally produced by lamination, preferably by coextrusion. The layer formation allows, in particular, the advantages that the various additives employed contribute to the film in a desired manner.

The substrate film may comprise one or more layers, monolayer substrate films are preferred.

The surface properties and surface roughness may be influenced by an optional additional coating of the substrate film with solutions or dispersions containing, inter alia, crosslinkable, curable or already crosslinked or cured substances or particles, as is known in the art. The coating is preferably carried out using an in-line coating process, i.e., coating the film between the stretching stages or after the orientation.

Optional surface modification of the polyester-based film using electric corona discharge may be carried out in a manner known in the art after completion of the film, i.e., after the thermosetting.

Although substrate films of different thickness may be used, a preferred substrate film has a thickness of from 10 to 25 μm, preferably from 10 to 20 μm. PET, PBT and PTT films are commercially available from several suppliers such as films of the brand names Sarafil® PET films (Polyplex), Melinex® and Mylar® PET films (Tekra), or Hostaphan® PET films (Mitsubishi Polyester Film). The films may also be prepared as described above from the respective polymers that are commercially available from e.g. BASF, DuPont, Lanxess, Sinopec, RTP Company and others.

### Laminated Film

### Structure and Preparation

Generally, a laminated film refers to a multilayer structure comprising several films and/or layers. In the present invention the laminated film comprises, or consists of, a sealant film and a substrate film of any of the above-described embodiments, laminated to each other.

In the laminated film, the substrate and the sealant film are connected to each via the outer layer O of the sealant film and a layer of the substrate film. The inner layer I of the sealant film forms the inner layer of the laminated film, and it is used as the sealing layer of the laminated film. Respectively, the substrate film forms or contains the outer layer of the laminated film.

Connection, i.e. lamination of the substrate and the sealant film to each other may be affected by any conventional lamination device using any conventional lamination method, such as adhesive lamination, including both solvent-based and solvent-less adhesive lamination using any conventional, commercially available adhesive. The adhesive may be applied to the sealant and/or the substrate film in any suitable manner. For example, the methods may include, the use of a laminating machine, gravure coating, roll coating, wire rod coating, spray coating etc. The film surface(s) for application of the adhesive may be corona treated to increase surface energy and to provide enough wettability for the adhesive components.

Lamination may alternatively be carried out without any adhesive, as sandwich lamination with or without a melt web, which may be pressed between the films. Such melt web may be any conventional melt web material based on polyethylene, such as LDPE. Lamination may further be performed via extrusion coating technique. All these lamination methods are well known in the art and described in literature.

Preferably, lamination is performed by use of an adhesive (such as a solvent-less adhesive). The adhesive may form a layer between the sealant and the substrate film.

Preferably, the adhesive has a weight per square meter of 1.0 g/m² to 3.5 g/m², more preferably from 1.2 g/m² to 2.5 g/m².

Preferably, the adhesive (or the adhesive layer) makes up to less than 5 wt. % of the total weight of the laminated film. The percentage of adhesive is usually dependent on the total weight of the laminated film, which correlates with the thickness of the laminated film. For example, laminated films of about 75 μm preferably comprise up to 4 wt. % of adhesive, based on the total weight of the laminated film, while laminated films of about 130 μm preferably comprise up to 3 wt. % of adhesive, based on the total weight of the laminated film.

Preferably, the laminated film has a thickness of 45 to 150 μm, more preferably 50 to 140 μm and most preferably 50 to 120 μm.

Preferably, the laminated film consists of the sealant film, the substrate film and optionally an adhesive layer between the polyethylene sealant film and the substrate film.

Preferably, no further polymers except of the polymers of the sealant film, the substrate film and optionally the adhesive layer are contained in the laminated film. Exceptions are polymeric additives as generally used in the art.

A simple structure of the laminated film and the absence of a variety of polymer classes enables more efficient recycling of the laminated film.

### Properties

The laminated film according to the present invention is characterized by excellent sealing properties. These properties are conferred by the sealant film comprising a specific inner layer composition. The LLDPE used in the inner layer composition has a density between 915 and 925 kg/m³ (and the particular example has a density of 918 kg/m³) and leads to a seal initiation temperature at 5 N (SIT) of the inner layer of the laminated film of less than 100° C. As demonstrated in the example section, the example IE2 according to the invention reached a seal initiation temperature of 95.1° C. When compared to the other examples, where LLDPEs with the same density were used (i.e. CE5 and CE7), the seal initiation temperature of the inventive example was at least 5° C. lower. Only LLDPEs with much lower density of 912 or 914 kg/m³, respectively, (CE4 and CE3) showed comparative low seal initiation temperature. However, low density LLDPEs usually suffer from drawbacks such as stickiness.

When a comparison between the sealant films is drawn, it can be seen that the sealant film used in the laminated film of the invention shows a superior seal initiation temperature to all comparative examples (IE1 vs. CE1-CE4).

Accordingly, the laminated film has a seal initiation temperature at 5 N (SIT) of less than 100° C., preferably less than 99° C., more preferably less than 98° C., when measured at the inner surface of the laminated film. Preferably, the laminated film has a seal initiation temperature at 5 N (SIT) of from 85 to 100° C., preferably from 90 to 99° C., when measured at the inner surface (inner layer I) of the laminated film. The seal initiation temperature at 5 N (SIT) is determined according to ASTM F 2029 and ASTM F 88.

In a particular embodiment, the seal initiation temperature SIT (5 N) of the laminated film further satisfies the following relation (1):

$$SIT ( ° C . ) \leq 1.6278 \times density of component AI ( kg / {m}^{3} ) - 1395 , \qquad ( I )$$

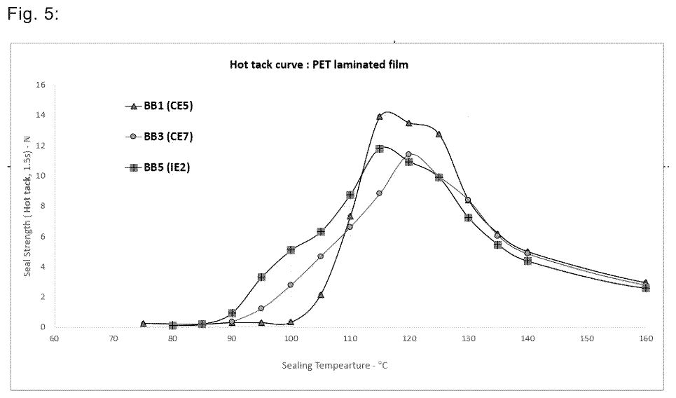

the seal initiation temperature being determined at the inner layer of the polyethylene sealant film according to ASTM F2029, ASTM F88. This mathematical relation (1) correlates the density of the LLDPE polymer used as component AI in the present invention with the seal initiation temperature of the laminated film. This relation illustrates the relatively low seal initiation temperature at relatively high density of the LLDPE when compared with the conventional LLDPEs. In FIG. 4, densities of the LLDPEs used in the examples are plotted against the SIT temperatures of the respective laminated films. The comparative examples follow a relation: SIT (° C.)=1.6278× density of LLDPE (kg/m³)−1393 (illustrated by the approximated line), while the SIT temperature is lower for the LLDPE of the inventive example, which has a comparatively high density.

Preferably, the laminated film has a hot tack temperature at 1 N of less than 98° C., preferably less than 95° C., such as less than 93.5° C., when measured at the inner layer surface (inner layer I) of the laminated film. Preferably, the laminated film has a hot tack temperature at 1 N of from 80 to 98° C., preferably from 85 to 95° C., when measured at the inner layer surface (inner layer I) of the laminated film. The hot tack temperature at 1 N is determined according to ASTM F1921.

The laminated film according to the present invention has improved mechanical properties along with good optical properties. With a good heat resistance, as conferred by the substrate film, the laminated film may run smoothly on high-speed VFFS machines.

For example, the tensile modulus (at 1% secant) is a measure of the strength characteristics in the film's elastic region and represents the actual deformation at a selected point on the stress-strain curve. As a result, the tensile modulus provides valuable insight into stiffness and resistance to elongation in use, or, how extensible the film is during the packaging operation like Form, Fill & Seal (FFS) machine and/or under normal use tensions of packaging. A high tensile modulus is very advantageous.

Preferably, the laminated film has a tensile modulus (1% secant modulus) in machine direction (MD) of at least 900 MPa, preferably of at least 1000 MPa. Preferably, the laminated film has a tensile modulus (1% secant modulus) in machine direction (MD) of from 900 MPa to 1400 MPa, preferably from 1000 MPa to 1300 MPa. The tensile modulus (1% secant modulus) in machine direction (MD) is determined according to ASTM D882.

Preferably, the laminated film has a tensile modulus (1% secant modulus) in transverse direction (TD) of at least 800 MPa, preferably of at least 900 MPa. Preferably, the laminated film has a tensile modulus (1% secant modulus) in transverse direction (TD) of from 800 MPa to 1400 MPa, preferably from 900 MPa to 1300 MPa. The tensile modulus (1% secant modulus) in transverse direction (TD) is determined according to ASTM D882.

Preferably, the laminated film has a relative tear resistance in machine direction (MD) of from 4.0 to 6.0 N/mm, more preferably from 4.2 to 5.5 N/mm. Preferably, the laminated film has a relative tear resistance in transverse direction (TD) of from 4.0 to 6.0 N/mm, more preferably from 4.1 to 5.5 N/mm. The relative tear resistance is determined according to ISO 6383-2.

Preferably, the laminated film has a deformation at maximum force of from 20 to 40 mm, and/or a maximum force of 150 to 200 N, and/or an energy to maximum force of 1.5 to 3.0 J. These parameters are determined according to ASTM D5748.

Preferably, the laminated film has a dart drop impact (DDI) of at least 350 g, more preferably at least 400 g. Preferably, the laminated film has a dart drop impact (DDI) of from 350 to 700 g, more preferably of from 400 to 650 g. The dart drop impact (DDI) is determined according to ASTM D1709 “method A”, preferably on laminated films of a thickness of from 45 to 150 μm, more preferably 50 to 140 μm and most preferably 50 to 120 μm.

Preferably, the laminated film has a coefficient of friction of less than 0.40, more preferably of less than 0.35, when measured at the inner surface; and/or of less than 0.30, more preferably of less than 0.20, when measured at the outer surface. Preferably, the laminated film has a coefficient of friction of from 0.10 to 0.40, more preferably from 0.15 to 0.35, when measured at the inner surface; and/or from 0.05 to 0.30, more preferably from 0.08 to 0.20, when measured at the outer surface. The coefficient of friction is determined according to ISO 8295 at dynamic condition (in/in or out/out).

The laminated film according to the present invention shows very good optical properties (i.e. haze and gloss) and is, thus, well suitable for packaging applications, where the requirements on aesthetics are high.

Preferably, the laminated film has a haze value of less than 12%, more preferably of less than 10%. Preferably, the laminated film has a haze value of from 3 to 12%, more preferably of from 5 to 10%. The haze value is determined according to ASTM D1003 as a measure for the transparency of the film and the value indicates good transparency.

Preferably, the laminated film has a gloss value of at least 80, more preferably at least 85. Preferably, the laminated film has a gloss value of from 80 to 140, more preferably from 85 to 130. The gloss value (GU) is determined at 45° according to ASTM D2457 at the inner or outer surface, preferably at the outer surface, of the laminated film.

### Article & Use

The invention also relates to an article comprising the laminated film according to the present invention. Preferred articles are packaging articles, preferably flexible packaging articles, such as pouches, like stand up pouches, sacks, bag, sachets, lamitubes etc.

The invention further relates to the use of the laminated film according to the present invention for packaging of an article. Particularly, it may be used in (Vertical) Form, Fill and Seal packaging technology or in the formation of pouches, such as stand up pouches, sacks, bags, sachets or lamitubes.

Specific articles and uses are heavy duty shipping sacks, detergent pouches, and articles/uses to pack different food items like rice, wheat, cereals, flours, food grains, pet-foods, and non-food items like detergent/washing powders, construction materials, chemicals and other materials.

Any one of the embodiments of the invention described herein can be combined with one or more of these embodiments. Particularly, any embodiment described for the laminated film of the invention is applicable to the use of the laminated film or the article.

Moreover, the invention relates to the use of a polyethylene sealant film comprising an inner layer I, which is made of an inner layer composition comprising from 75 to 95 wt. % of a component AI that is a linear low density ethylene polymer having a density of from 915 to 925 kg/m³ and a melt flow rate (MFR₂) of from 0.5 to 3.0 g/10 min, determined according to ISO 1133, the wt. % being based on the total weight of the inner layer composition, for improving the sealing performance of a substrate film comprising a polyester polymer, selected from the group consisting of polyethylene terephthalate, polybutylene terephthalate and polytrimethylene terephthalate, preferably being a polyethylene terephthalate, upon lamination of the sealant film to the substrate film.

For specific embodiments of the inner layer composition, the polyethylene sealant film and the substrate film, it is referred to the embodiments described at the relevant positions above. These embodiments are applicable to the present use as well.

In the following, the invention will further be illustrated by way of examples, which refer to the figures showing:

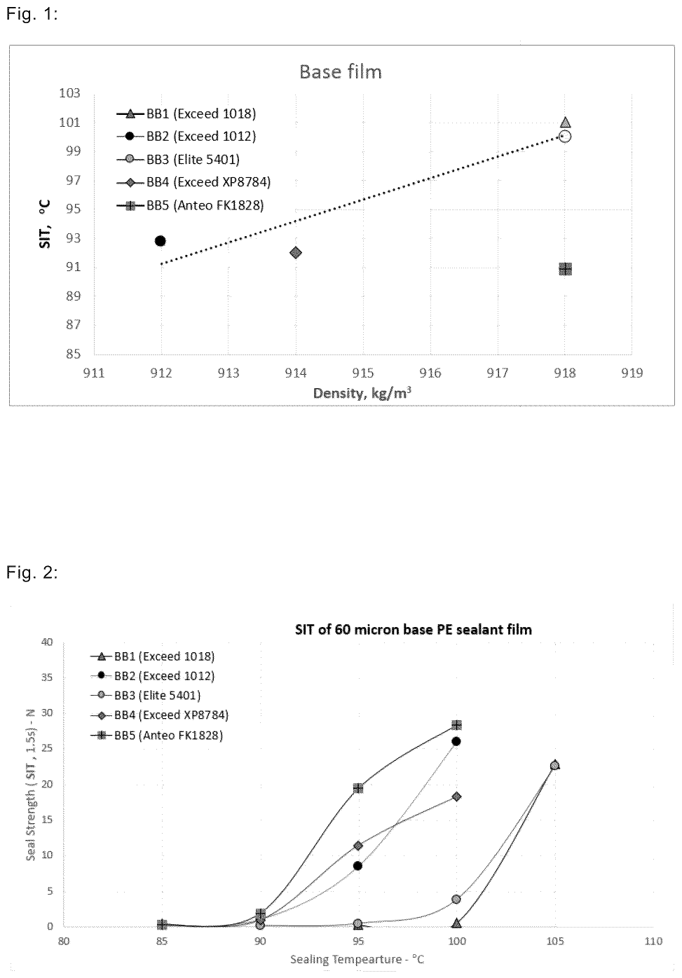

FIG. 1: Heat seal initiation temperature at 5 N measured at the inner layer of the sealant films before lamination vs. the densities of the LLDPEs of the examples.

FIG. 2: Curves of the seal temperatures of the sealant films before lamination.

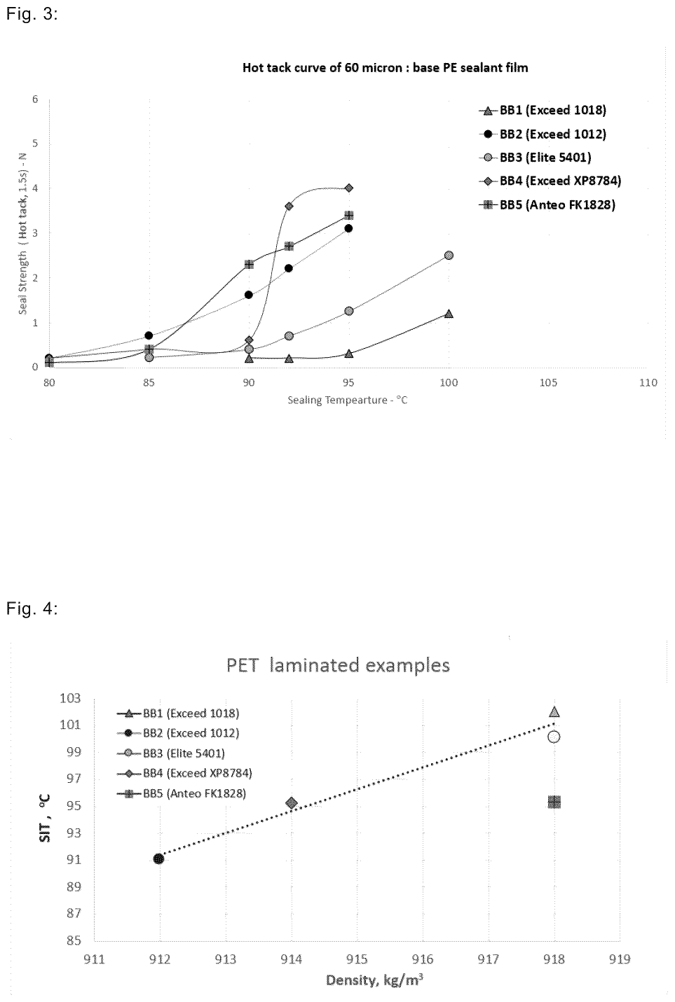

FIG. 3: Curves of the hot tack temperatures of the sealant films before lamination.

FIG. 4: Seal initiation temperature at 5 N measured at the inner layer of the sealant films in the laminated films vs. the densities of the LLDPEs of the examples.

FIG. 5: Curves of the hot tack temperatures of the laminated films.

### MEASUREMENT AND DETERMINATION METHODS

The following definitions of terms and determination methods apply for the above general description of the invention as well as to the below examples, unless otherwise defined.

### a) Measurement of Melt Flow Rate MFR

The melt flow rate (MFR) is determined according to ISO 1133 and is indicated in g/10 min. The higher the melt flow rate, the lower the viscosity of the polymer. The MFR is determined at 190° C. for polyethylene and at a loading of 2.16 kg (MFR₂), 5.00 kg (MFR₅) or 21.6 kg (MFR₂₁).

The quantity FRR (flow rate ratio) is an indication of molecular weight distribution and denotes the ratio of flow rates at different loadings. Thus, FRR_{21/5} denotes the value of MFR₂₁/MFR₅.

### b) Density

Density of the polymer was determined according to ISO 1183-1:2004 (method A) on compression molded specimen prepared according to ISO 17855-2 and is given in kg/m³.

### c) GPC

### 1) GPC Conventional Method

Molecular weight averages (M_{z}, M_{w} and Mₙ), molecular weight distribution (MWD) and its broadness, described by polydispersity index, PDI=M_{w}/Mₙ (wherein Mₙ is the number average molecular weight and M_{w} is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3× Agilent-PLgel Olexis and 1× Agilent-PLgel Olexis Guard columns was used. As mobile phase 1,2,4-trichlorobenzene (TCB) stabilized with 250 mg/L 2,6-Di tert butyl-4-methyl-phenol) was used. The chromatographic system was operated at column temperature of 160° C. and detector at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , {α}_{PS} = 0.655 \\ {K}_{PE} = 39 \times {10}^{- 3} mL / g , {α}_{PE} = 0.725$$

A third order polynomial fit was used to fit the calibration data.

All samples were prepared in the concentration range of around 1 mg/ml and dissolved at 160° C. for 3 (three) hours for PE in fresh distilled TCB stabilized with 250 ppm Irgafos168 under continuous gentle shaking

### 2) GPC Viscosity Method

Molecular weight averages (M_{z}, M_{w} and Mₙ), Molecular weight distribution (MWD) of LDPE is determined by GPC-viscosity method using universal calibration. Molecular weight averages (M_{w}, Mₙ), Molecular weight distribution (MWD) and its broadness, described by polydispersity index, PDI=M_{w}/Mₙ (wherein Mₙ is the number average molecular weight and M_{w} is the weight average molecular weight) were determined by Gel Permeation Chromatography (GPC) according to ISO 16014-4 2019. A PL 220 (Polymer Laboratories) GPC equipped with an IR4 infrared detector, an online four capillary bridge viscometer (PL-BV 400-HT) was used. 3× Olexis and 1× Olexis Guard columns from Polymer Laboratories as stationary phase and 1,2,4-trichlorobenzene (TCB, stabilized with 250 mg/L 2,6-Di tert butyl-4-methyl-phenol) as mobile phase at 160° C. and at a constant flow rate of 1 mL/min was applied. 200 μL of sample solution were injected per analysis. The corresponding detector constant of the viscometer as well as the inter-detector delay volumes were determined with a narrow PS standard (MWD=1.01) with a molar mass of 132900 g/mol and an intrinsic viscosity of 0.4789 dl/g. The detector constant of the IR4 detector was determined using NIST1475a with dn/dc of 0.094 cm³/g.

The column set was calibrated using universal calibration (according to ISO 16014-2:2019) with at least 15 narrow MWD polystyrene (PS) standards in the range of 0.5 kg/mol to 11 600 kg/mol. The corresponded intrinsic viscosities of the PS standards were calculated from their corresponding concentration (IR4), online viscometer signals, and determined detector constants for polystyrene. For low molecular weight PS with a molar mass below 3000 g/mol the initial weight out concentration is used, due to end group effects in the IR detector.

The molecular weight of the sample (M₂) at each chromatographic slice using the universal calibration approach can be calculated by following correlation:

log M₁[η₁]=V_{R}=log M₂[η₂]
with: M₁ Molar mass of PS
   η₁ intrinsic viscosity of the PS
   M₂ Molar mass of sample
   η₂ intrinsic viscosity of sample
   V_{R} Retention volume

All data processing and calculation was performed using the Cirrus Multi-Offline SEC-Software Version 3.2 (Polymer Laboratories a Varian inc. Company).

All samples were prepared by dissolving 5.0-9.0 mg of polymer in 8 mL (at 160° C.) of stabilized TCB (same as mobile phase) for 2.5 hours for PP or 3 hours for PE at max. 160° C. under continuous gentle shaking.

### d) Comonomer Content

The comonomer content was determined as described in WO2019081611, pages 31 to 34.

### e) Mechanical Properties

### Tensile Modulus and Tensile Stress at Break

Film tensile properties are determined at 23° C. according to ISO 527-3 with a specimen Type 2 using blown films. Tensile modulus in machine direction (MD) and tensile modulus in transverse direction (TD) were determined as 1% secant modulus with 5 mm/min test speed and 50 mm gauge length according to ASTM D882.

Tensile stress at break were determined according to ISO 527-3 specimen Type 2 with 50 mm gauge length and 500 mm/min test speed. The film samples were produced as described below under “Examples”.

### Tensile Strain at Break

Tensile strain at break in machine (MD) and transverse direction (TD) were determined according to ISO 527-3 on films with a thickness as indicated and produced as described below under “Examples”.

### Relative Tear Resistance

Relative tear resistance in machine (MD) and transverse direction (TD) were determined according to ISO 6383-2 on films with a thickness as indicated and produced as described below under “Examples”.

### Puncture Resistance

Protrusion Puncture Resistance testing is conducted according to ASTM D5748 on films with a thickness as indicated and produced as described below under “Examples”. This test method determines the resistance of a film sample to the penetration of a probe with specific size of 19 mm diameter pear-shaped TFE fluorocarbon coated at a standard low rate, a single test velocity (250 mm/min). Performed at standard conditions, the test method imparts a biaxial stress loading. Cut the film specimens 150 mm×150 mm to fit into the jig and conditioning done at 23±2° C. at 50 t 5% relative humidity.

By this method, the following parameters were obtained: maximum force/puncture resistance force (N), deformation at maximum force (mm) and energy to maximum force/puncture resistance energy (J).

The puncture resistance force (N) is the maximum force or highest force observed during the test and puncture resistance energy (J) is the energy used until the probe breaks the test specimen, both are measured using the high accuracy 500 N loadcell and crosshead position sensor.

### Dart Drop Impact

Dart drop impact (DDI) was determined according to ASTM D1709 “method “A” on films with a thickness as indicated and produced as described below under “Examples”.

### f) Optical Properties

Gloss, clarity and haze as measures for the optical appearance of the films were determined according to ASTM D2457 (gloss) and ASTM D1003 (haze and clarity) on films with thickness as indicated and produced as described below under “Examples”.

Gloss of the outer and inner layers was determined according to ASTM D2457 at an angle of 45°. As the gloss meter, BYK-Gardner Micro-TRI-Gloss Meter was used, and gloss values are recorded and reported as gloss units (GU). Gloss was determined on both surfaces of the film separately.

### g) Coefficient of Friction

Coefficient of friction, both in/in and out/out, at dynamic and static conditions, were determined according to ISO 8295.

### h) Seal Initiation Temperature (SIT)

In principle, heat seal is formed by bonding two films (polymeric) in the way that surfaces are pressed together into a close contact while being at least in partially molten. This test method also covers the evaluation part after the heat seal process is performed. The force required to separate a test strip of material containing the seal was measured using UTM (also to identify the mode of specimen failure). Following the ASTM F 2029; ASTM F 88 standard, a tested specimen with a film produced as described below under “Examples” where the sealed surfaces are selected. For testing, a minimum of five specimens shall be used for each seal temperature. The term “seal initiation temperature” (SIT) is specified as the “seal initiation temperature at 5 N” and refers to the temperature at which a seal is formed that will have a strength of 5 N after cooling. The temperature at which a heat seal forms immediately after the sealing operation (sealing time 1.0 seconds, sealing pressure 3 bar for less than 65 micron film and sealing time 1.5 seconds for 65 micron and above thickness), the strength of the heat seal being measured at a specified time interval (at least 24 hrs after completion of the sealing cycle and after the seal has cooled to ambient temperature and reached maximum strength).

### i) Hot Tack Temperature

This test method is a procedure to determine the temperature needed to reach a defined seal strength for a film sample under defined seal time and pressure following the ASTM F1921 standard. Thus, a hot tack test measures the strength of heat seals in films immediately after a seal is made before cooling to room temperature conditions. For testing, film specimens of width 25 mm and length >250 mm is required for each seal temperature. Hot tack temperature at 1 N force (° C.) was measured as per ASTM F1921 in the following conditions: sealing pressure 3 bars, dwell/sealing time 1 second, cooling/delay time 100 mili second (release), test/peel speed 200 mm/s for less than 65 micron film. For 65 micron and above thickness, dwell/sealing time of 1.5 second was used with similar test conditions.

### j) Thickness

Thickness of the films was determined according to ASTM D6988.

### EXAMPLES

3-layered sealant (base) films consisting of a core layer, an inner layer and an outer layer were produced. Example IE1 (BB5) represents a sealant film that is used in the laminated film of the invention, while examples CE1 (BB1), CE2 (BB2), CE3 (BB3) and CE4 (BB4) are comparative sealant film. Each of the sealant films has a thickness of 60 μm. Thickness of the core layers of each of the sealant films is 60% of the total thickness of the respective film and the thickness of each of the external layers (i.e. inner layer and outer layer) is 20% of the total thickness of the respective film.

The sealant films are non-oriented films (as per definition). The details of all films are summarized below:

TABLE 1
Sealant film samples (formulations in wt. %).

| | Outer Layer | | Inner Layer |
|---|---|---|---|
| Samples | (lamination layer) | Core Layer | (sealant layer) |
| Film layer | Layer O | Layer C | Layer I |
| Thickness layer ratio | 20% | 60% | 20% |
| Layer thickness | 12 | 36 | 12 |
| (μm) | | | |
| BB1/CE1 | 80% C4-LLDPE | 80% C4-LLDPE | 80% Exceed 1018 |
| with Exceed 1018 | (FM1810) | (FM1818) | 20% LDPE (FT6236) |
| | 20% LDPE (FT6230) | 20% LDPE (FT6230) | |
| BB2/CE2) | 80% C4-LLDPE | 80% C4-LLDPE | 80% Exceed 1012 |
| with Exceed 1012 | (FM1810) | (FM1818) | 20% LDPE (FT6236) |
| | 20% LDPE (FT6230) | 20% LDPE (FT6230) | |
| BB3/CE3) | 80% C4-LLDPE | 80% C4-LLDPE | 80% Elite 5401 |
| with Dow Elite 5401 | (FM1810) | (FM1818) | 20% LDPE (FT6236) |
| | 20% LDPE (FT6230) | 20% LDPE (FT6230) | |
| BB4/CE4) | 80% C4-LLDPE | 80% C4-LLDPE | 80% Exceed XP8784 |
| with Exceed XP8784 | (FM1810) | (FM1818) | 20% LDPE (FT6236) |
| | 20% LDPE (FT6230) | 20% LDPE (FT6230) | |
| BB5/IE1 | 80% C4-LLDPE | 80% C4-LLDPE | 80% Anteo FK1828 |
| with Anteo FK1828 | (FM1810) | (FM1818) | 20% LDPE (FT6236) |
| | 20% LDPE (FT6230) | 20% LDPE (FT6230) | |

The polymers used for making the films are given below.

TABLE 2
Characteristics of the polymers used for making the
films of the inventive and comparative examples.

| Resin | | | MFR₂ | Density |
|---|---|---|---|---|
| name | Producer | Type | (g/10 min) | (kg/m³) |
| Anteo | Borouge | Bimodal 1-butene, 1-hexene | 1.5 | 918 |
| FK1828 | | ethylene terpolymer | | |
| FM1810 | Borouge | Bimodal 1-butene ethylene | 1.1 | 918 |
| FM1818 | | copolymer | | |
| FT6230 | Borealis/ | tubular LDPE | 2 | 923 |
| FT6236 | Borouge | | | |
| Exceed | ExxonMobil | Unimodal LLDPE: 1-hexene | 1.0 | 918 |
| 1018KB | | ethylene copolymer | | |
| Elite | Dow | Unimodal LLDPE: 1-octene | 1.0 | 918 |
| 5401G | Chemical | ethylene copolymer | | |
| | Company | | | |
| Exceed | ExxonMobil | Unimodal LLDPE: 1-hexene | 1.0 | 912 |
| 1012MK | | ethylene copolymer | | |
| Exceed | ExxonMobil | Unimodal LLDPE: 1-hexene | 0.8 | 914 |
| XP8784MK | | ethylene copolymer | | |

The sealant films were laminated to conventional PET substrates (12 μm) to form PE sealant film—PET substrate laminates, wherein the laminates were named as follows:
IE2: inventive laminate comprising sealant film IE1 (BB5)
CE5: comparative laminate comprising sealant film CE1 (BB1)
CE6: comparative laminate comprising sealant film CE2 (BB2)
CE7: comparative laminate comprising sealant film CE3 (BB3)
CE8: comparative laminate comprising sealant film CE4 (BB4)

### Experimental

### Preparation of Sealant Films

Blown films (60 μm) were produced on a Polyrema (Reifenhauser blown film line with internal bubble cooling system) having an output of 150 kgs/hr and cooling air temperature were in between 12 to 16° C. The details as listed below.

TABLE 3
Blown film line parameters.
Blown film line parameters

| Die diameters | 180 | mm |
|---|---|---|
| Die gap | 1.8 | mm |
| Blow up ratio (BUR) | 2.2:1 | |
| Bubble cooling | IBC | |
| Cooling air temperature | 14° | C. |
| Corona treatment | 44 | dynes |

Table 4 lists the temperature profiles of the blown film line i.e., the temperatures used for different layers of the blown film extruders at different locations of the blown film line.

TABLE 4
Temperature profiles (° C.) of the blown film line.

| | | | | | | Post | Post | Post |
|---|---|---|---|---|---|---|---|---|
| | Extruder | Extruder | Extruder | Extruder | Extruder | Extruder | Extruder | Extruder |
| Layer | zone 1 | zone 2 | zone 3 | zone 4 | zone 5 | zone 6 | zone 7 | zone 8 |
| Outer Layer (A) | 155 | 170 | 180 | 190 | 190 | 190 | 200 | 200 |
| Core/Middle Layer (B) | 155 | 170 | 180 | 190 | 190 | 190 | 200 | 200 |
| Inner Layer (C) | 155 | 170 | 180 | 190 | 190 | 190 | 200 | 200 |

| | |
|---|---|
| Die zones | 195 |

### Lamination Process

The PET films were laminated with different sealant PE examples at Henkel Corporation using adhesive LA7732 and hardener LA6159 mixed at 2:1 ratio. Lamination was done on a solvent-less laminator at a running speed of 150 meters/min with an adhesive of 2 g/m². The corona treatment intensity on the carrier web was 2.5 kW and on the secondary web also 2.5 kW.

### Film Properties

### Sealant Films (Before Lamination)

### Mechanical and Other Properties

The sealant films were tested for several properties. The methods and results are listed below. As can directly be seen, the sealant film IE1 used for the laminated film of the invention show very good mechanical performance when compared to the comparative films. Haze and coefficient of fraction are also improved over most of the comparative films.

TABLE 5
Properties of the sealant films (60 μm PE base films).

| | | | BB1 | BB2 | BB3 | BB4 | BB5 |
|---|---|---|---|---|---|---|---|
| Sealant Film | Method | | CE1 | CE2 | CE3 | CE4 | IE1 |
| Film Thickness, μm | ASTM D6988 | | 60 | 61 | 62 | 60 | 61 |
| Tensile Modulus (1% secant), MPa | ASTM D882 | MD | 233 | 210 | 199 | 206 | 231 |
| | | TD | 269 | 243 | 236 | 240 | 268 |
| Tensile Stress at Break, MPa | ISO 527-3 | MD | 41 | 40 | 39 | 40 | 45 |
| | | TD | 34 | 34 | 34 | 33 | 39 |
| Tensile Strain at Break, % | | MD | 609 | 625 | 616 | 571 | 655 |
| | | TD | 697 | 672 | 746 | 678 | 762 |
| Dart Drop Impact (DDI), g | ASTM D1709 Method A | | 372 | 576 | 276 | 594 | 363 |
| Haze, outside, % | ASTM D1003 | | 11.8 | 9.8 | 10.8 | 12.2 | 11.7 |
| Static COF inside-inside >96 hr | ISO 8295 | | 0.16 | 0.16 | 0.19 | 0.12 | 0.14 |
| Dynamic COF inside-inside >96 hr | | | 0.15 | 0.15 | 0.19 | 0.13 | 0.14 |
| Static COF outside-outside >96 hr | | | 0.29 | 0.28 | 0.28 | 0.29 | 0.25 |
| Dynamic COF outside-outside >96 hr | | | 0.26 | 0.25 | 0.24 | 0.25 | 0.22 |

### Sealing Performance

Sealing behavior of the base PE sealant films was determined by measuring the seal initiation temperature (SIT) at 5 N and hot tack temperature at 1 N at the inner (sealing) layer I of the inventive and comparative sealant films. In general, lower heat seal initiation temperature and lower hot tack temperature indicates a better performance in seal integrity, which results in higher packaging speed while the films are in use for vFFS packaging applications.

Table 6 and FIGS. 2 and 3 demonstrate the obtained results, wherein the sealant film IE1 used for the laminated film of the invention shows the lowest seal initiation temperature at 5 N and the lowest hot tack temperature at 1 N.

FIG. 1 depicts the seal initiation temperature as a function of density of the LLDPE polymer used in the sealing layer. As can be seen, generally, the seal initiation temperature decreases with decreased density of the polymer. However, the IE1 film shows a seal initiation temperature, which is 9° C. to 10° C. lower than the two comparative CE1 and CE3 films of the same density of 918 kg/m³.

TABLE 6
Sealing properties of the sealant films (60 μm PE films).

| | | BB1 | BB2 | BB3 | BB4 | BB5 |
|---|---|---|---|---|---|---|
| Sealant PE Film | Method | CE1 | CE2 | CE3 | CE4 | IE1 |
| Film Thickness, μm | ASTM D6988 | 60 | 61 | 62 | 60 | 61 |
| Seal Initiation | ASTM F2029 | 101.0 | 92.7 | 100.3 | 92.0 | 90.9 |
| Temperature at | ASTM F88 | | | | | |
| 5N, ° C. | | | | | | |
| Hot Tack | ASTM F1921 | 98.9 | 86.7 | 93.6 | 90.3 | 86.6 |
| Temperature at | | | | | | |
| 1N, ° C. | | | | | | |

### Laminated Films (Sealant Film Laminated to PET Film)

### Mechanical and Other Properties

Different properties of the laminated films were measured and the results are listed below.

TABLE 7
Properties of the laminated films.

| | | BB1 | BB2 | BB3 | BB4 | BB5 |
|---|---|---|---|---|---|---|
| Laminated Film | Method | CE5 | CE6 | CE7 | CE8 | IE2 |
| Film Thickness, μm | ASTM D6988 | 76.2 | 71.5 | 76.7 | 73.4 | 77.3 |
| COF inside-inside >96 hr, dynamic | ISO 8295 | 0.20 | 0.23 | 0.29 | 0.30 | 0.26 |
| COF inside-inside >96 hr, static | | 0.22 | 0.25 | 0.33 | 0.32 | 0.30 |
| COF outside-outside >96 hr, dynamic | | 0.18 | 0.16 | 0.15 | 0.17 | 0.13 |
| COF outside-outside >96 hr, static | | 0.20 | 0.21 | 0.23 | 0.23 | 0.18 |
| MD Relative Tear Resistance, N/mm | ISO 6383-2 | 5.48 | 4.99 | 5.24 | 4.84 | 4.77 |
| TD Relative Tear Resistance, N/mm | | 4.46 | 4.33 | 5.64 | 4.65 | 4.36 |
| MD Tensile Modulus, MPa | ASTM D882 | 1073 | 1066 | 1052 | 1074 | 1088 |
| TD Tensile Modulus, MPa | | 1050 | 955 | 946 | 930 | 1004 |
| Gloss, inside, 45° MD | ASTM D2457 | 97 | 100 | 92 | 95 | 92 |
| Gloss, outside 45° MD | | 93 | 101 | 91 | 94 | 89 |
| Haze, inside, % | ASTM D1003 | 8.9 | 7.1 | 9.3 | 8.9 | 8.9 |
| Haze, outside, % | | 8.4 | 7.3 | 9.3 | 9.0 | 9.1 |
| Deformation at Maximum Force, mm | ASTM D5748 | 26.9 | 28.7 | 25.1 | 29.0 | 29.3 |
| Maximum Force, N | | 161.6 | 177.4 | 148.5 | 177.2 | 177.5 |
| Energy to Maximum Force, J | | 1.8 | 2.1 | 1.5 | 2.2 | 2.2 |
| Dart Drop Impact (DDI), g | ASTM D1709 Method A | 462 | 449 | 480 | 492 | 462 |

All laminated films show good stiffness (determined as tensile modulus), which is expected to be based on the PET substrate. The inventive film IE2 has the highest MD tensile modulus with good impact balance.

Also puncture resistance (energy to break) of the IE2 film is higher than the values for the films with LLDPE of similar density in the sealant layers. However, it was surprisingly found that dart drop impact of all the laminated films are in the range of 450 to 490 g. This range does not differ significantly from the range obtained for the (base) sealant films. Only the CE2 and CE4 (base) sealant films have very high dart drop impact, however once these films are laminated to the PET films, they do not perform better than the other laminated films.

Optical properties of the IE2 film are comparable with the comparative film, and are satisfying for the use of the laminated film is packaging applications. Also the coefficient of friction is relatively low and makes the IE2 film suitable for fast packaging operations on a vFFS machine.

### Sealing Performance

Sealing behavior of the laminated films was determined and is summarized below.

TABLE 8
Sealing properties of the laminated films.

| | | BB1 | BB2 | BB3 | BB4 | BB5 |
|---|---|---|---|---|---|---|
| Laminated Film | Method | CE5 | CE6 | CE7 | CE8 | IE2 |
| Film Thickness, μm | ASTM D6988 | 72 | 72 | 73 | 72 | 75 |
| Seal Initiation | ASTM F2029, | 102.0 | 90.7 | 100.1 | 95.2 | 95.1 |
| Temperature at | ASTM F88 | | | | | |
| 5N, ° C. | | | | | | |
| Hot Tack | ASTM F1921 | 101.9 | 90.9 | 93.9 | 85.7 | 90.2 |
| Temperature at | | | | | | |
| 1N, ° C. | | | | | | |

The seal initiation temperature of the IE2 film is 95.1° C., which is lower than the seal initiation temperature of the CE5 and CE7 films, which contain an LLDPE with the same density of 918 kg/m³ (i.e. SIT being between 10° and 102° C.). Only the CE6 film with an LLDPE of a much lower density (912 kg/m³) shows a lower SIT temperature.

FIG. 4 depicts the seal initiation temperature of the laminated films as a function of density of the LLDPE polymer used in the sealing layer of the respective laminated films, and illustrates the described correlation.

Similarly, the hot tack temperature of the inventive IE2 film is lower than those of the CE5 and CE7 films and is about 90° C. Among all laminated films, only the CE8 film shows a lower hot tack temperature and this film contains an LLDPE of a much lower density (914 kg/m³) than the IE2 film.

FIG. 5 depicts the hot tack temperature curves of the IE2, CE5 and CE7 laminated films. The IE2 film shows a broader curve of hot tack strength in a temperature range between 95° C. and 130° C., which is broader than those of the comparative CE5 and CE7 films.

The improved sealing behavior of the inventive IE2 film will result in superior performance in faster packaging operations on a vFFS machine.

1. A laminated film comprising:
a) a polyethylene sealant film comprising at least an outer layer O, an inner layer I and a core layer C, the core layer C being present between the outer layer O and the inner layer I,
wherein the inner layer I is made of an inner layer composition comprising from 75 to 95 wt. % of a component AI that is a linear low density ethylene polymer having a density of from 915 to 925 kg/m³ and a melt flow rate (MFR₂) of from 0.5 to 3.0 g/10 min, determined according to ISO 1133, the wt. % being based on the total weight of the inner layer composition; and
b) a substrate film laminated to the polyethylene sealant film,
wherein the substrate film comprises a polyester polymer, selected from the group consisting of polyethylene terephthalate, polybutylene terephthalate and polytrimethylene terephthalate, and mixtures thereof;
wherein the seal initiation temperature SIT (5 N) of the laminated film is less than 100° C., determined at the inner layer of the polyethylene sealant film according to ASTM F2029, ASTM F88.

2. The laminated film according to claim 1, wherein the seal initiation temperature SIT (5 N) of the laminated film satisfies the following relation (1):
SIT(° C.)≤1.6278×density of component AI (kg/m³)−1395 (I),
the seal initiation temperature being determined at the inner layer of the polyethylene sealant film according to ASTM F2029, ASTM F88.

3. The laminated film according to claim 1, wherein the component AI is a multimodal linear low density ethylene polymer.

4. The laminated film according to claim 1, wherein the component AI has a melt flow rate (MFR₂) of from 1.0 to 2.0 g/10 min, determined according to ISO 1133, and/or has a molecular weight distribution (MWD) of from 3.0 to 5.0, determined according to the GPC conventional method specified in the description.

5. The laminated film according to claim 1, wherein the component AI is a bimodal terpolymer comprising an ethylene polymer component (A) and an ethylene polymer component (B), wherein the ethylene polymer component (A) has a higher melt flow rate (MFR₂), determined according to ISO 1133, than the ethylene polymer component (B), and the ethylene polymer component (A) is a copolymer of ethylene and 1-butene and the ethylene polymer component (B) is a copolymer of ethylene and 1-hexene.

6. The laminated film according to claim 1, wherein the inner layer composition further comprises from 5 to 25 wt. % of a component BI that is a low density ethylene polymer having a density of more than 915 kg/m³, based on the total weight of the inner layer composition.

7. The laminated film according to claim 1, wherein the polyethylene sealant film comprises from 70 to 95 wt. % of an ethylene polymer having a density of from 915 to 925 kg/m and from 5 to 30 wt. % of a low density ethylene polymer, both wt. % being based on the total weight of the polyethylene sealant film.

8. The laminated film according to claim 1, wherein at least one of the outer layer O and core layer C is made of a composition comprising from 50 to 90 wt. % of a component AO or AC, the wt. % being based on the total weight of the respective layer composition, being a linear low density ethylene polymer, the component AO or AC having a density of from 915 to 925 kg/m and a melt flow rate (MFR₂) of from 0.2 to 2.0 g/10 min, determined according to ISO 1133.

9. The laminated film according to claim 1, wherein the polyethylene sealant film has a thickness of 40 to 100 μm, and the substrate film has a thickness of 10 to 20 μm, the thickness being determined according to ASTM D6988.

10. The laminated film according to claim 1, wherein the substrate film is a monolayer film, preferably an oriented monolayer film, and/or the polyester polymer is polyethylene terephthalate.

11. The laminated film according to claim 1, wherein the laminated film consists of the polyethylene sealant film, the substrate film and optionally an adhesive layer between the polyethylene sealant film and the substrate film.

12. The laminated film according to claim 1, wherein the laminated film has at least one of the following properties:
a) a seal initiation temperature SIT (5 N) of from 90 to 99° C., determined at the inner layer of the polyethylene sealant film according to ASTM F2029, ASTM F88;
b) a hot tack temperature (1 N) of from 85 to 95° C., determined at the inner layer of the polyethylene sealant film according to ASTM F1921;
c) a tensile modulus (1% secant) in machine direction (MD) of at least 1000 MPa, and/or a tensile modulus (1% secant) in transverse direction (TD) of at least 900 MPa, determined according to ASTM D882;
d) a haze value of less than 10%, determined according to ASTM D1003, and/or a gloss value of at least 80, determined at the inner layer of the polyethylene sealant film at 45° according to ASTM D2457; and/or
e) a dart drop impact of at least 400 g, determined according to ASTM D1709 “method A”.

13. An article comprising the laminated film according to claim 1.

14. Use of the laminated film according to claim 1 for packaging of an article.

15. A process for improving the sealing performance of a substrate film comprising a polyester polymer selected from the group consisting of polyethylene terephthalate, polybutylene terephthalate and polytrimethylene terephthalate, and mixtures thereof, comprising:
laminating to the substrate film a polyethylene sealant film comprising an inner layer I, which is made of an inner layer composition comprising from 75 to 95 wt. % of a component AI that is a linear low density ethylene polymer having a density of from 915 to 925 kg/m and a melt flow rate (MFR₂) of from 0.5 to 3.0 g/10 min, determined according to ISO 1133, the wt. % being based on the total weight of the inner layer composition.

16. The process of claim 15, wherein the polyester polymer is polyethylene terephthalate.

17. The laminated film according to claim 3, wherein the component AI is a multimodal terpolymer of ethylene with two comonomers selected from alpha-olefins having from 4 to 10 carbon atoms.

18. The laminated film according to claim 17, wherein the two copolymers are 1-butene and 1-hexene.

19. The laminated film according to claim 5, wherein the total comonomer content in the component AI is from 1 to 5 mol %.

20. The laminated film according to claim 8, wherein the linear low density ethylene polymer comprises a multimodal linear low density ethylene polymer.
